(19) United States
(12) Patent Application Publication
(10) Pub. No.: US 2003/0041873 A1
(43) Pub. Date: Mar. 6, 2003

(54) Dental strip and method of use thereof

(76) Inventor: Dana Contratto, Washington, DC (US)

Correspondence Address: CROWELL & MORING LLP, P.O Box 14300, Washington, DC, 20044-4300, US

(21) Appl. No.: 09/939,565

(22) Filed: Aug. 28, 2001

(51) Int. Cl. A61C 15/00

(52) U.S. Cl. 132/321

(57) ABSTRACT

A dental strip made of a suitable plastic which is of a thickness that it will fit snugly in the interproximal spaces of the teeth, yet not so snugly that it cannot be moved back and forth in the same manner as dental floss. The dental strip is preferably made of a biaxially oriented polyethylene terephthalate and has a thickness of from about 0.0015 inch to about 0.0045 inch, a length of from about one inch to about 6 inches, and a width of about ⅛ inch to about ½ inch. The Dental strip may have a coating holding a flavoring agent, a sweetening agent, and/or a therapeutic agent.

### BACKGROUND AND SUMMARY OF THE INVENTION

This invention relates to an article for cleaning the interproximal spaces and surfaces of the teeth and, more particularly, this invention relates to dental strips and to a method for their use.

Dental practitioners have recommended for many years that, while brushing the teeth regularly is essential for proper oral health, more than that is required. Regular “flossing,” or use of dental floss, is essential. The user holds the dental floss in both hands and inserts it in the interproximal spaces, that is, the spaces between the teeth. The user then moves the floss back and forth to both remove foreign matter and to stimulate the gums. Thus, the dental floss serves several purposes. It removes foreign matter and food particles, it assists in preventing the build-up of plaque, and it helps in preventing gum disease.

Dental floss is usually sold in rolls enclosed in a package which has a tear-off device. The user tears off a piece of floss, winds the ends around a finger of each hand, and then awkwardly proceeds to use it. This is ordinarily done in the privacy of one's home. Various holders and application devices with dental floss mounted across a generally U-shaped opening are also available. Some users find these more convenient and easier to use. Nevertheless, the use of these devices in public places is generally considered unsightly. Toothpicks are still widely used to remove food particles, but they do not serve the dual purpose of dental floss as completely.

It is, therefore, an object of the present invention to provide a device which possesses the positive aspects of dental floss but is free of the disadvantages thereof.

It is another object of the present invention to provide a device for cleaning the interproximal spaces and surfaces of the teeth which is simple and convenient to carry and use.

It is still another object of the present invention to provide a device for stimulating the gums.

It is yet another object of the present invention to provide a method for cleaning the interproximal spaces and surfaces of the teeth and for stimulating the gums.

Consistent with the foregoing and other objects, in one aspect of the instant invention, a dental strip made of a suitable plastic which is of a thickness that it will fit snugly in the interproximal spaces of the teeth, yet not so snugly that it cannot be moved back and forth in the same manner as dental floss, is provided. The dental strips according to this invention can be packaged to be conveniently carried by the user and can be inconspicuously used. They may also be produced in dental floss like containers or rolls so as to be dispensed at whatever lengths are desirable, like tape is often dispensed.

A suitable thickness is about 0.0015 inch to about 0.0045 inch (about 73 μm. to about 114 μm). The preferred thickness is about 0.003 inch (about 76 μm).

The strip is of a suitable length that it can be snugly gripped at one end between two fingers of one hand or, if the user prefers, at each end by both hands, and can be manipulated sufficiently to provide gum stimulation. The minimum operable length is about one inch (about 2.54 cm). The maximum length is dictated only by the convenience of the user who must manipulate it within his/her mouth. Thus, the maximum length could be as long as about 6 inches (about 15.24 cm) or more. The preferred length is between about 2 inches (about 5 cm) and about 4 inches (about 10 cm). The most preferred length is about 3 inches (about 7.6 cm).

The width of the strip is dictated only by practical considerations. It should comfortably fit in the interproximal spaces of the teeth and may protrude slightly beyond the teeth when resting on the gum or may not. Thus, the width is in the range of about ⅛ inch (about 3.175 mm) to about ½ inch (about 12.7 mm). The preferred width is about ⅜ inch (about 9.525 mm).

The dental strip of my invention may be made of any suitable material which is non-toxic and safe to use, as well as being flexible enough to manipulate but stiff enough to clean the surfaces of the teeth and provide the necessary gum stimulation. It will be apparent to those skilled in the art what types of materials are suitable. In general any plastic which is well-known for use as the substrate in making magnetic media to be used as computer diskettes, or so-called “floppy disks”, is suitable. Such plastics include, but are not limited to, polyolefins, polyesters, polyamides, and polyimides. Polyethylene terephthalate is preferred. In addition a plastic coated paper of a suitable thickness and strength could be used.

In another aspect of the present invention, a method is provided for using the dental strips.

### DETAILED DESCRIPTION OF THE PREFERRED EMBODIMENT

In a preferred embodiment, a dental strip according to the invention is fabricated of biaxially oriented polyethylene terephthalate. A sheet of biaxially oriented polyethylene terephthalate (PET) 0.003 inch (76 μm) thick is cut into strips 3 inches (about 7.6 cm.) long by ⅜ inch (about 9.5 mm) wide. The particular sheet of biaxially oriented polyethylene terephthalate used was the magnetic recording medium of a computer diskette and contained a magnetic coating and other coating ingredients ordinarily used in such devices. Those skilled in the art will recognize that the magnetic coating is not necessary and would ordinarily be omitted.

On the other hand the plastic sheet could optionally have a coating of an ingestible binder carrying a flavoring agent, a sweetener, and/or a therapeutic agent. Suitable coatings include microcrystalline wax, beeswax, polyethylene glycols, alkylene-vinyl co-polymers, acrylic emulsions, polyamides, and the like. Suitable flavoring agents are mint, cinnamon, or even “bubble gum”. Sweetening agents include saccharine and other synthetic sweeteners. Suitable therapeutic agents are sodium or stannous fluoride, cetyl pyridinium chloride, chlorhexidine gluconate. The proportions of flavoring agents, sweeteners, and therapeutic agents are well known in the art as taught, for example, in U.S. Pat. Nos. 6,026,829 and 6,251,410, both of which are incorporated herein in their entireties by reference. Similarly, the coating ingredients are well known in the art as exemplified by the aforesaid U.S. Pat. Nos. 6,026,829 and 6,251,410. Methods for coating the substrates can also be gleaned from, for example, U.S. Pat. Nos. 5,501,903 and 6,194,047, both of which are incorporated herein in their entireties by reference.

As is well known, dental floss is held taut by gripping a length of the floss at each end, using both hands, and manipulating it between the teeth. On the other hand, the dental strip of the instant invention may be gripped at one end only due to its inherent rigidity as compared to floss. Yet, if the user feels more comfortable gripping it with both hands, he/she may do so. The user inserts the dental strip between the teeth and creates a reciprocating motion to stimulate the gums. The user also may move the strip up-and-down to cause the edge of the strip to scrape the sides of the teeth, thereby preventing plaque build-up.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A dental strip comprising a flat strip of a flexible polymer foil which is resistant to tearing.

2. A dental strip as claimed in claim 1, wherein said polymer is selected from the group consisting of polyolefins, polyesters, polyamides, and polyimides.

3. A dental strip as claimed in claim 2, having a thickness of from about 0.0015 inch to about 0.0045 inch, a length of from about one inch to about 6 inches, and a width of about ⅛ inch to about ½ inch.

4. A dental strip as claimed in claim 3, wherein said length is from about 2 inches to about 4 inches.

5. A dental strip as claimed in claim 4, wherein said length is about 3 inches, and said width is about ⅜ inch.

6. A dental strip as claimed in claim 5, wherein said thickness is about 0.003 inch.

7. A dental strip as claimed in claim 2, wherein said polymer is a biaxially oriented polyethylene terephthalate.

8. A dental strip as claimed in claim 7, having a thickness of from about 0.0015 inch to about 0.0045 inch, a length of from about one inch to about 6 inches, and a width of about ⅛ inch to about ½ inch.

9. A dental strip as claimed in claim 8, wherein said length is from about 2 inches to about 4 inches.

10. A dental strip as claimed in claim 9, wherein said length is about 3 inches, and said width is about ⅜ inch.

11. A dental strip as claimed in claim 10, wherein said thickness is about 0.003 inch.

12. A dental strip as claimed in claim 8, further comprising a coating of a microcrystalline wax, beeswax, a polyethylene glycol, an alkylene-vinyl co-polymer, an acrylate or methacrylate, or a polyamide.

13. A dental strip as claimed in claim 12, wherein said coating further comprises at least one of a flavoring agent, a sweetening agent, and a therapeutic agent.

14. A dental strip as claimed in claim 13, wherein said flavoring agent is selected from the group consisting of mint, cinnamon, and bubble gum.

15. A dental strip as claimed in claim 13, wherein said sweetening agent is selected from the group consisting of saccharine and other synthetic sweeteners.

16. A dental strip as claimed in claim 13, wherein said therapeutic agent is selected from the group consisting of sodium or stannous fluoride, cetyl pyridinium chloride, and chlorhexidine gluconate.

17. The combination of a package and a plurality of dental strips as claimed in claim 1.

18. A package comprising a holder and a dental strip coil of a length that a plurality of dental strips as claimed in claim 1 may be separated from said coil, said holder comprising a cutter adapted to cut individual dental strips from said coil upon manipulation by a user.

19. A method of maintaining oral hygiene comprising inserting a dental strip as claimed in claim 1 between the interproximal spaces of the teeth and manipulating the dental strip in such a manner as to clean the interproximal spaces.

20. A kit comprising at least one dental strip and instructions for use of the dental strip setting forth the method of claim 19.
